(19) United States
(12) Patent Application Publication
(10) Pub. No.: US 2004/0117187 A1
(43) Pub. Date: Jun. 17, 2004

(54) Speech recognition apparatus

(75) Inventor: Masahiko Ikeda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/612,938

(22) Filed: Jul. 7, 2003

(30) Foreign Application Priority Data
Dec. 12, 2002 (JP) 2002-360356

(51) Int. Cl. G10L 15/14

(52) U.S. Cl. 704/256

(57) ABSTRACT

An assembly of word models produced from a word model producer is sent to a matching object word selector to select one word model as matching object from them. A word matching processor judges whether or not a score of a path root of a present state serving as matching object is within a predetermined range being set based on a maximum value of the score, which is memorized in a maximum value memory buffer connected to the word matching processor. When the score of the path root is with in the above-described range, the score of this path root is designated as count object and a cumulative score is obtained. On the other hand, when the score of the path root is outside the above-described range, calculation of score for the state of the matching object is omitted.

### BACKGROUND OF THE INVENTION

1. Field of the Invention

The present invention relates to a speech recognition apparatus, and more particular to a speech recognition apparatus which is capable of realizing high-speed word speech matching processing.

2. Description of the Background Art

The Japanese Patent Application Laid-Open No. 8-221090(1996) Column 4 to column 8, FIG. 1 (patent document 1) discloses a conventional speech recognition method. According to this patent document 1, a hidden Markov model network is expressed by using states and nodes. On this network, according to a Viterbi algorithm, all of the items required for recognition processing is combined with the cumulative matching score and then propagated and processed for each speech recognition candidate produced in each state. According to this method, the calculation volume for the cumulative matching score can be reduced. The required memory capacity is relatively small.

However, the above-described method is based on a speech recognition relying on the Viterbi algorithm for performing frame synchronized processing. Application of this technique is limited.

### SUMMARY OF THE INVENTION

In view of the above-described problems, the present invention has an object to provide a speech recognition apparatus capable of increasing the processing speed by reducing the number of required matching operations even in the matching processing of speech recognition performed for each word.

To accomplish the above and other related objects, the present invention provides a speech recognition apparatus including an acoustic processing section for converting an input speech signal given as a time-series signal into a feature vector and outputting a plurality of dissected frames, a word model producing section for producing at least one word model based on a recognition object word prepared beforehand and an acoustic model, a matching processing section for performing matching processing for collating the above-described at least one word model with the feature vector for each word by using the Viterbi algorithm which obtains a final probability along a state sequence giving a maximum probability, and a maximum value memorizing section for memorizing a maximum value in each frame of a score calculated based on the probability for a plurality of states contained in the above plurality of frames, wherein the matching processing section selects a calculation object state in which a score is to be calculated from the plurality of states based on the maximum value of the score and performs thinning-out processing for omitting calculation of scores for the states not selected as the calculation object state.

The matching processing section selects the calculation object state having a score to be calculated from the plurality of states based on the maximum value of the score and performs the thinning-out processing for omitting the calculation of scores for the states not selected as the calculation object state. Accordingly, even in the matching processing of speech recognition performed for each word, it becomes possible to perform the thinning-out processing similar to a so-called beam search method. The time required for the matching processing of one word can be reduced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual view explaining the matching processing based on HMM;

FIG. 2 is a block diagram showing an arrangement of a speech recognition apparatus in accordance with a first embodiment of the present invention;

FIG. 3 is a flowchart explaining an operation of the speech recognition apparatus in accordance with the first embodiment of the present invention;

FIG. 4 is a flowchart explaining an operation of the speech recognition apparatus in accordance with the first embodiment of the present invention;

FIG. 5 is a block diagram showing an arrangement of a speech recognition apparatus in accordance with a second embodiment of the present invention;

FIG. 6 is a flowchart explaining an operation of the speech recognition apparatus in accordance with the second embodiment of the present invention;

FIG. 7 is a block diagram showing a modified arrangement of the speech recognition apparatus in accordance with the second embodiment of the present invention;

FIG. 8 is a conceptual view explaining matching processing based on DP matching method; and

FIG. 9 is a conceptual view explaining matching processing based on DP matching method.

### DESCRIPTION OF THE PREFERRED EMBODIMENTS

<Introduction>

Prior to the explanation of preferred embodiments of the present invention, the hidden Markov model (hereinafter, referred to as HMM) used in the word speech matching will be explained.

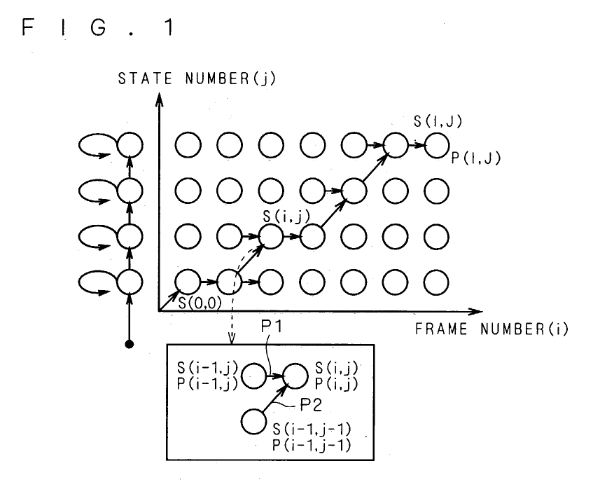

FIG. 1 is a view schematically showing HMM matching processing applied to a word consisting of four states linked together. In this case, the state is equivalent to a phoneme serving as minimum unit of speech. The phonemes are generally known as vowels or consonants.

In FIG. 1, the abscissa represents a frame number (i) in the case that an input word (i.e., speech) entered as a time-series signal is dissected into a plurality of frames each having a predetermined length. The ordinate represents a phoneme number (j) of a registered word. A circle mark (◯) is placed on each lattice point of a matrix. Shown on each lattice point are an acoustic feature amount extracted from each frame of the input word and information relating to a matching probability in each state of the registered word. In the following explanation, the frame number is referred to as state number while each lattice point on the matrix is referred to as demiphoneme.

The HMM matching processing of FIG. 1 shows a state transition sequence consisting of a plurality of states linked by arrows starting from an initial state S(0,0) positioned at a lower left of the drawing and reaching to a final state S(I, J) positioned at an upper right of the drawing. In other words, this illustration shows that the state transition sequence is not limited to only one. For example, when an arbitrary state S (i, j) is addressed, there is two paths available for reaching this state S (i, j) as shown in the drawing. More specifically, path P1 is a path linked from a state S (i−1, j) and is a transition from the same state number (referred to as self loop). On the other hand, path P2 is a path linked from a state S (i−1, j−1) and is a transition from a different state number.

It is now assumed that P (i−1, j) represents a cumulative value of probabilities (i.e., cumulative score) accumulated in the process of reaching the state S (i−1, j). In this case, a probability wk1 reaching to the state S (i, j) via the path P1 is expressed by the following numerical formula (1). The initial state S (0, 0) has a score given as initial value. For example, P (0, 0)=1.

wk1=P(i−1, j)×a{(i−1, j), (i, j)}×b{(i−1, j), (i, j), Yi} (1)

In the above formula, a{(i−1, j), (i, j)} represents a transit probability from the state S (i−1, j) to the state S(i, j) and b{(i−1, j), (i, j), yi} represents a probability of a voiced sound feature vector Yi appearing in the transition from the state S (i−1, j) to the state S (i,j).

Furthermore, when P (i−1, j−1) represents the cumulative score accumulated in the process of reaching the state S (i−1, j−1), a probability wk2 reaching to the state S (i, j) via the path P2 is expressed by the following numerical formula (2)

wk2=P(i−1, j−1)×a{(i−1, j−1), (i, j)}×b{(i−1, j−1), (i, j), Yi} (2)

In the above formula, a{(i−1, j−1), (i, j)} represents a transit probability from the state S (i−1, j−1) to the state S (i, j) and b{(i−1, j−1), (i, j), yi} represents a probability of a voiced sound feature vector Yi appearing in the transition from the state S (i−1, j−1) to the state S (i, j).

Based on the probabilities wk1 and wk2 obtained in the above-described numerical formulas (1) and (2), the cumulative score P (i, j) at the state S (i, j) is expressed by the following numerical formula (3).

P(i, j)=max(wk1, wk2) (3)

Namely, in the case of passing the path P1 and the path P2, the larger one between the probabilities wk1 and wk2 is designated as cumulative score P (i, j) at the state S (i, j).

The above-described processing is performed repetitively until the final frame is processed. Then, the cumulative score P (I, J) obtained at the final state is regarded as word score.

In the event that there is only one path root, the score of this path root is directly used to calculate its own score and accordingly the above formula (3) is not used.

When the logarithmic expression is applied to the above-described numerical formulas (1) and (2), they can be converted into formulas of summation. This is why the obtained probabilities are called the cumulative scores.

The above-described HMM matching processing is conventionally well known as left-to-right model.

The HMM matching processing is characterized in that the similarity between the input word and the registered word is judged based on the largeness of the cumulative score of output signals obtained along a certain state transition sequence starting from the initial state and reaching the final state. The above-described HMM matching processing is performed for a plurality of registered words. The registered word having the largest word score is judged as having the highest similarity to the input word. The algorithm obtaining probabilities in this manner along the state sequence giving the maximum probability is called the Viterbi algorithm.

<A. First Embodiment>

<A-1. Apparatus Arrangement and Operation>

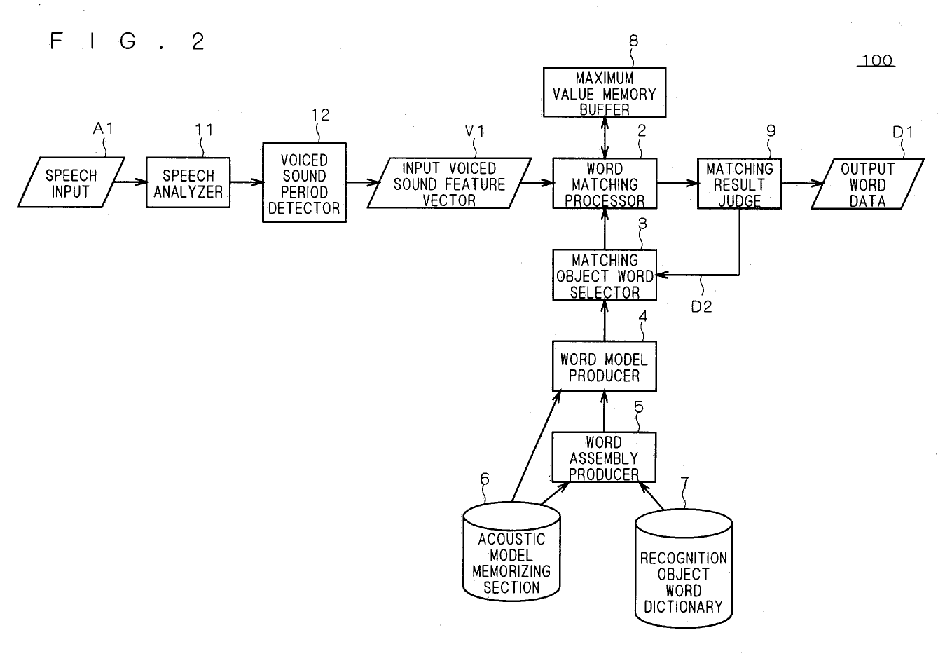

An arrangement and operations of a speech recognition apparatus in accordance with a first embodiment of the present invention will be explained with reference to FIGS. 2 to 4.

<A-1-1. Overall Operation of the Apparatus>

FIG. 2 is a block diagram showing an arrangement of a speech recognition apparatus 100 in accordance with the first embodiment. As shown in FIG. 2, a speech input A1 entered as a time-series signal is sent to a speech analyzer 11. The speech analyzer 11 extracts acoustic feature amounts for respective frames. More specifically, in the speech analyzer 11, a speech signal is subjected to an LPC (i.e., linear predictive coding) analysis to obtain a power spectrum of speech. Spectrums of sound source signals chiefly originated from vibration of vocal cord and also spectrums of acoustic filters (i.e., articulation filters) formed by lung, jaw, tongue or the like are separated from the power spectrum of speech. The information relating only to the characteristics of articulation filters are extracted as the acoustic feature amount. The cepstrum analysis is used to extract the acoustic feature amount. In some cases, cepstrum coefficients obtained through the cepstrum analysis may be converted into mel cepstrum coefficients based on human aural characteristics. The extraction of these acoustic feature amounts can be performed by using a conventionally known technique and, accordingly, will not be explained hereinafter.

After the acoustic feature amount is extracted by the speech analyzer 11, a voiced sound period detector 12 detects voiced sound periods based on the power (i.e., intensity of sound). Then, the voiced sound period detector 12 produces an input voiced sound feature vector V1 as time-series data of the acoustic feature amount. The speech analyzer 11 and the voiced sound period detector 12 may be collectively called an acoustic processing section.

The input voiced sound feature vector V1, as time-series data, is sent to a word matching processor 2. The word matching processor 2 performs the HMM matching processing for collating the input voiced sound feature vector V1 with a registered word.

Hereinafter, the action for selecting a word as matching object to be subjected to the HMM matching processing will be explained with reference to operations of a matching object word selector 3, a word model producer 4 and a word assembly producer 5.

For example, a recognition object word dictionary 7, constituted by an EEPROM (i.e., electronically erasable programmable ROM), stores a plurality of words (i.e., registered words) in accordance with Roman alphabet expressions of text form. The word assembly producer 5 accesses the recognition object word dictionary 7 and produces, for example, an assembly of similar words having a common term, consisting of several leading phonemes, starting by similar voiced sounds. In the above action, the registered words expressed by Roman alphabet expressions are converted into an acoustic model (HMM) according to which the probability distribution registered in an acoustic model memorizing section 6 is disposed on a matrix. Thus, the comparison is performed between acoustic models to produce the above-described assembly.

As described above, from the fact that each acoustic model has a probability distribution, it is preferable to compare the probability distributions of respective acoustic models about only several leading phonemes to judge the similarity in the state of distribution and then produce the assembly of similar acoustic models.

The word model producer 4 performs an action for converting the word assembly produced by the word assembly producer 5 into an assembly of word models having the format allowing the word matching processor 2 to collate.

The above-described production of word models and conversion into the acoustic models can be performed in response to each entry of the input voiced sound feature vector V1, or can be performed only when the recognition object word dictionary 7 is renewed if the assembly information is held in the word assembly producer 5. Alternatively, the assembly of word models can be stored in the word model producer 4.

The above-described actions of the speech analyzer 11, the voiced sound period detector 12, the matching object word selector 3, a matching result judge 9, the word model producer 4, and the word assembly producer 5 can be replaced by the operation of CPU (i.e., central processing unit) under a program.

The assembly of word models produced by the word model producer 4 is sent to the matching object word selector 3. The matching object word selector 3 selects one word model as matching object.

The word model selected by the matching object word selector 3 is sent to the word matching processor 2. The word matching processor 2 performs matching processing for comparing the input voiced sound feature vector V1, i.e., the input speech, with the word model selected by the matching object word selector 3. This matching processing is the processing using the previously explained HMM.

The word matching processor 2 repeats the HMM matching processing for a plurality of words models to be successively selected by the matching object word selector 3. Then, the word matching processor 2 obtains the word score representing a final cumulative score of each word model. Of course, the action of word matching processor 2 can be replaced by the operation of CPU which has the capability of serving as the word model producer 4 and the word assembly producer 5 as described above. However, an additionally provided DSP (i.e., digital signal processor) will also be able to act as the word matching processor 2.

The matching result judge 9 memorizes the word score of each word model sent from the word matching processor 2, and judges the word model having the highest word score as corresponding to a word entered by the speech input. The matching result judge 9 outputs an output word data D1 of the word mode thus identified. The matching result judge 9 has a function of feeding information D2 relating to the matching result back to the matching object word selector 3. The matching object word selector 3 improves the efficiency in its selecting operation based on the feedback information D2.

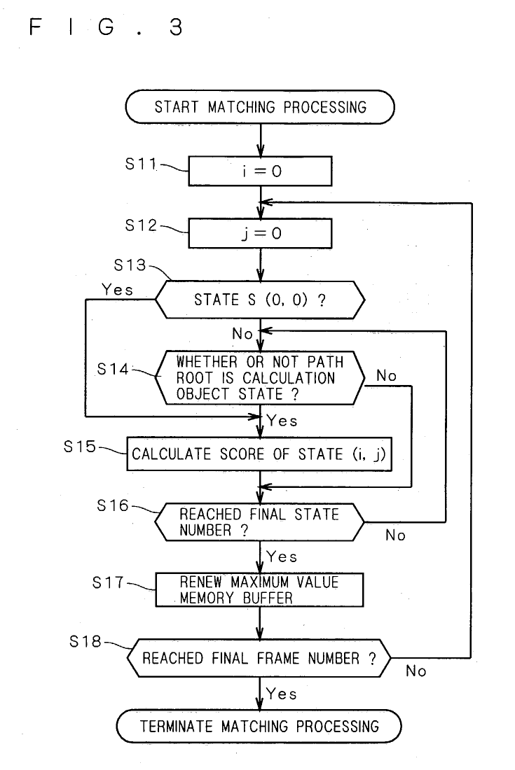

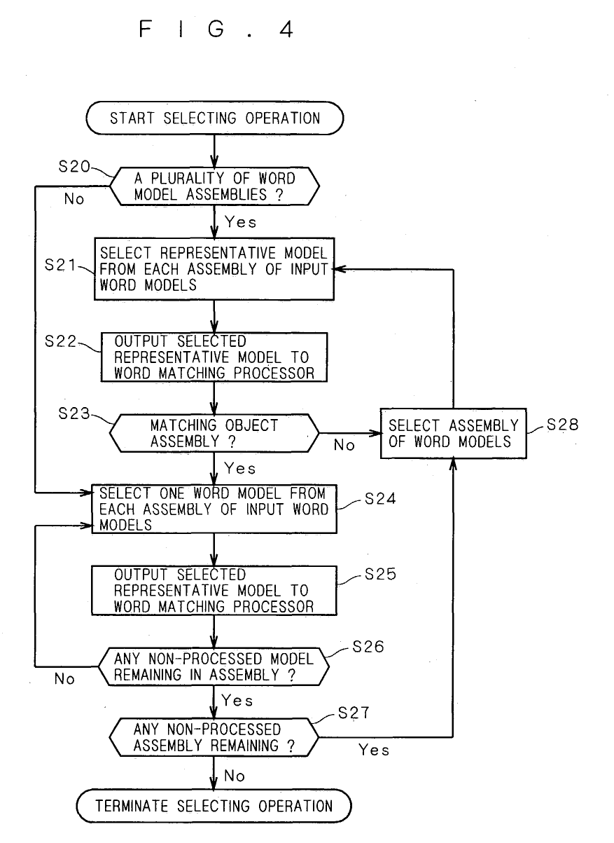

Hereinafter, the matching processing of the word matching processor 2 and the selecting operation of the matching object word selector 3, together with the operations of a maximum value memory buffer 8 and the matching result judge 9, will be explained with reference to the flowcharts shown in FIGS. 3 and 4. The matching processing will be explained with reference to the HMM matching processing shown in FIG. 1.

<A-1-2. Operation of Word Matching Processor>

The operation of word matching processor 2 will be explained with reference to FIG. 3. First of all, after starting the matching processing, a frame (i=0) having a frame number 0 is designated as matching object with respect to the input voiced sound feature vector V1 given as a time-series signal (step S11). Then, a state number 0(j=0) of the word model is designated (step S12). Accordingly, a state S (0, 0) is designated as matching object. In this case, the final frame number is J and the final state number is I.

Next, in step S13, it is judged whether or not the matching object is the state S (0, 0). When the matching object is the state S (0, 0), the processing flow proceeds to step S15 to obtain the score (step S13).

On the other hand, when the matching object is the state S (i, j) other than the state S (0, 0), it is further judged in step S14 whether or not a path root is a calculation object state.

This judgment is an operation for checking whether or not a state positioned immediately before the state S (i, j) presently serving as score obtaining object, i.e., a score of the path root, is within a predetermined range being set based on the maximum value of score of each frame, which is memorized in the maximum value memory buffer 8 connected to the word matching processor 2.

More specifically, the maximum value memory buffer 8 memorizes the maximum value of score for each frame of the input voiced sound feature vector V1. This value is obtained as a result of the matching processing having been previously done for the same input. However, as explained hereinafter, this value is renewable for each matching processing. In the event that the speech recognition apparatus 100 performs the matching processing for the first time, it is preferable to use a default value being set beforehand so as to correspond to a predicted value.

For example, the predetermined range of score is set to a region within a predetermined percentage of the maximum value of the score. The judgment is performed to check whether or not the score of the path root is within the predetermined range being thus determined.

When the score of the path root is within the above-described predetermined range, the score of this path root is designated as a count candidate. The cumulative score of state S (i, j) is obtained based on the numerical formula (3) (step S15). After obtaining the score, the processing flow proceeds to step S16.

In the case where there is only one path root, the score of this path root is counted to calculate the own score without using the numerical formula (3).

On the other hand, when the score of the path root is outside the above-described predetermined range, calculation of score for the state S (i, j) is omitted. Then, the processing flow proceeds to step S16.

In the step S16, it is judged whether or not the present state number has already reached the final number (J). When the present state number has not yet reached the final number, the state number is incremented by 1 and the processing of the step S14 and succeeding steps is repeated.

On the other hand, when the present state number has already reached the final number, the processing flow proceeds to step S17. In the step S17, the score of each state obtained through the matching processing performed for respective states having state numbers 0 to J is compared with the maximum value of score in the frame having a frame number being identified as present matching object memorized in the maximum value memory buffer 8. In the event that any higher core is obtained, the maximum value of score being currently memorized is renewed by the newly obtained higher score.

Next, in step S18, it is judged whether or not the present frame number has already reached the final number (I). When the present frame number has not yet reached the final number, the frame number is incremented by 1 and the processing of the step S12 and succeeding steps is repeated.

The meaning of the above-described operation is, for example, that the matching processing for all of the states having state numbers 0 to J of the frame of frame number 0 is performed first and then the matching processing for all of the states having state numbers 0 to J of the frame of frame number 1 succeeds.

When the present frame number has already reached the final number, it means that the matching operation for one word model selected by the matching object word selector 3 terminates.

As described above, some of the calculation of score is omitted by applying the predetermined threshold. This makes it possible to shorten the time required for the matching processing. According to the HMM matching processing, as explained with reference to FIG. 1, the state transition sequence has a start point at the state S (0, 0) and generally extends along a diagonal path to reach the final state S (I, J). There is a small possibility that the state transition sequence takes an extremely shifted excursion. From this, the calculation of score is generally unnecessary for the upper left corner region and the lower right corner region in the layout of FIG. 1. This is the reason why some of the calculation of score can be omitted.

As explained with reference to FIG. 1, the cumulative score at the final state S (I, J) is the word score. The word score of each word model is obtained by applying the processing of the above-described steps S11 through S18 to a plurality of word models successively selected by the matching object word selector 3.

<A-1-3. Operation of Matching Object Word Selector>

The matching object word selector 3 is explained as having a function of selecting one word model as matching object from the assembly of the word models produced by the word model producer 4. However, this is a basic operation shown by the steps S24 through S26 of FIG. 4. It is possible to perform a preprocessing operation shown in steps S21 through S23 prior to this basic operation.

More specifically, the matching object word selector 3 receives the assembly of word models produced from the word model producer 4. If a plurality of assemblies are present, it will be necessary to perform the matching processing for a plurality of word models contained in each of the plurality of assemblies. Therefore, it will probably take a long time to obtain the final output word data D1.

Hence, when there are a plurality of assemblies of word models, a representative model is selected from each assembly of word models. The selected representative model is sent to the word matching processor 2 and subjected to the matching processing therein. The word score resulting from this matching processing is compared with a judgment reference value being set beforehand by the matching result judge 9. From this comparison, when the word score is greatly different from the judgment reference value, the assembly of word models from which the above representative model is extracted is decided as unsuitable for the matching processing. This is called the preprocessing operation.

The assembly having been judged as unsuitable for the matching processing is no longer adopted as matching object.

The operation of matching object word selector 3, together with the above-described preprocessing operation, will be further explained with reference to FIG. 4.

First of all, after starting the word selecting operation, it is judged in step S20 whether or not a plurality of assemblies of word models are sent from the word model producer 4. When a plurality of assemblies are present, the processing flow proceeds to step S21. When there is only one assembly, the processing flow proceeds to step S24.

In step S21, a representative model is selected from each of the plurality of assemblies of word models entered from the word model producer 4. Namely, as explained in the operation of the word assembly producer 5, the production of an assembly of word models is, for example, realized by collecting similar acoustic models based on the comparison between their probability distributions about several leading phonemes. In this case, acoustic models in the assembly are classified according to the degree of similarity and the acoustic models having higher similarities are collected together. The acoustic model positioned in the center of the assembly is designated as representative model.

Next, in step S22, one of a plurality of representative models is selected and sent to the word matching processor 2 in which the HMM matching processing is applied to the selected representative model. In this case, the selection is performed at random.

The word score resulting from the HMM matching processing performed in the word matching processor 2 is sent to the matching result judge 9. The matching result judge 9 compares the entered word score with the judgment reference value being set beforehand. The judgment reference value can be set with reference to experimental values and, therefore, can be set to an average of the word scores having been previously obtained. Then, the judgment result with respect to the judgment whether or not the entered word score exceeds the judgment reference value is fed back as information D2 to the matching object word selector 3

Next, in step S23, it is judged whether the assembly of word models from which the above-described representative model is extracted is a matching object assembly or not based on the judgment result of the entered word score relative of the judgment reference value. When the assembly is judged as unsuitable for the matching processing, this assembly is excluded from the matching objects. Another assembly is selected (step S28), and the processing of steps S21 and succeeding steps is repeated.

On the other hand, when the assembly is judged as suitable for the matching processing in the judgment of step S23, the processing flow proceeds to step S24 to select one word model from this assembly. The selected word model is sent to the word matching processor 2 (step S25) and is then subjected to the matching processing according to the procedure explained with reference to FIG. 3.

Then, in step S26, it is judged whether or not the assembly includes any word model having not been processed yet. When there is any word model having not been processed yet, the processing of step S24 and succeeding steps is repeated. On the other hand, when all of the word models in the assembly is processed, the processing flow proceeds to step S27 to further judge whether or not there is any assembly having not been processed yet. When any non-processed assembly remains, the processing flow proceeds to the step S28 to select a new assembly. The selecting operation terminates at the time that the processing for all of the assemblies has completed.

<A-2. Characteristic Function and Effect>

According to the above-described speech recognition apparatus 100, in the HMM matching processing performed in the word matching processor 2, among a plurality of states, a judgment is made to check whether or not the score of a path root of the present state serving as matching object (i.e., a previous condition) is within the predetermined range being set based on the maximum value of score of each frame, which is memorized in the maximum value memory buffer 8 connected to the word matching processor 2. When the score of this path root is within the above-described range, the score of this path root is used as count object and the cumulative score is obtained. When the score of this path root is outside the above-described range, the calculation of score for the state of the matching object is omitted.

In this manner, even in the matching processing of speech recognition performed for each word, it becomes possible to perform the thinning-out processing similar to a so-called beam search method. The time required for the matching processing of one word can be reduced.

Furthermore, the word assembly producer 5 produces an assembly of similar words. The matching object word selector 3 selects the representative model from each word model, and sends the selected representative model to the word matching processor 2 in which the selected representative model is subjected to the matching processing. Then, to make a judgment as to whether or not the matching processing should be applied to the assembly of word models from which the above-described representative model is extracted, the preprocessing operation is performed based on the word score resulting from the above matching processing. Accordingly, the time required for the matching processing can be greatly reduced. The high-speed processing is realized.

<B. Second Embodiment>

<B-1. Apparatus Arrangement and Operation>

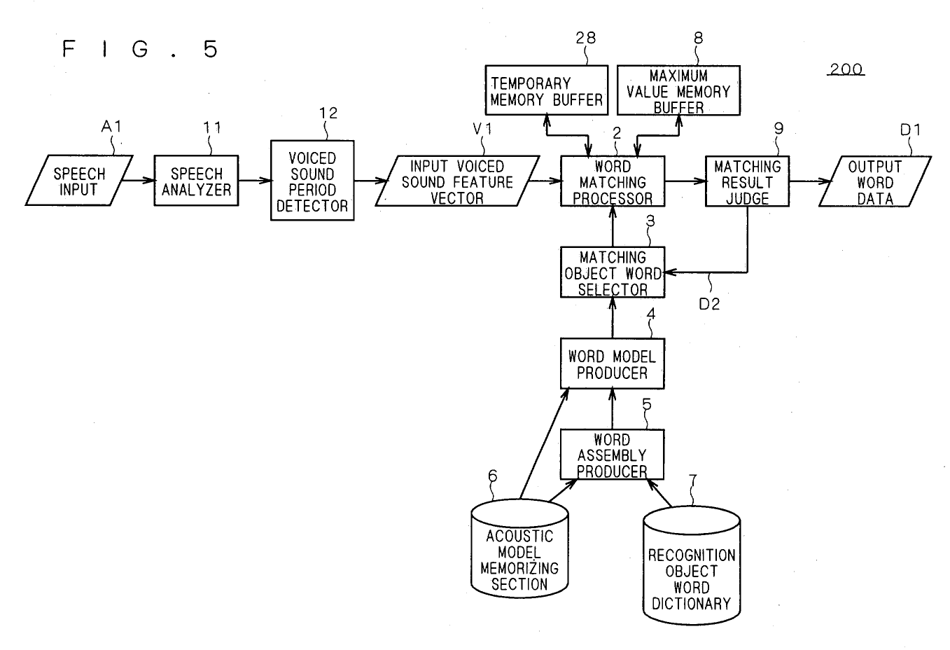

An arrangement and operations of a speech recognition apparatus in accordance with a second embodiment of the present invention will be explained with reference to FIGS. 5 to 7.

<B-1-1. Overall Operation of the Apparatus>

FIG. 5 is a block diagram showing an arrangement of a speech recognition apparatus 200 in accordance with the second embodiment. In FIG. 5, the same components shown in the speech recognition apparatus 100 explained with reference to FIG. 2 are denoted by the same reference numerals. Accordingly, no repetitive explanation will be given for these components.

As shown in FIG. 5, the input voiced sound feature vector V1 is sent as a time-series signal to a word matching processor 24 which performs the HMM matching processing for collating the input voiced sound feature vector V1 with the registered word. The word matching processor 24 basically performs the same operation as that of the word matching processor 2 shown in FIG. 2. In addition to the maximum value memory buffer 8, a temporary memory buffer 28 is connected to the word matching processor 24. The renewal procedure for the maximum value of score memorized in the maximum value memory buffer 8 is slightly different. The operation of the word matching processor 24 will be later explained in detail.

A word assembly producer 25 accesses the recognition object word dictionary 7 and produces, for example, an assembly of words similar in several leading phonemes. Meanwhile, the word assembly producer 25 receives the output word data D1 sent from the matching result judge 9 to perform statistical processing. Based on this statistical processing, the word assembly producer 25 gives a higher priority to a specific word having been frequently output from the word matching processor 24, so that the possibility of this specific word being selected by the matching object word selector 3 can be increased. For example, a higher priority is set to the word assembly including this frequently output word, or the priority of this specific word is increased in the word assembly.

<B-1-2. Operation of Word Matching Processor>

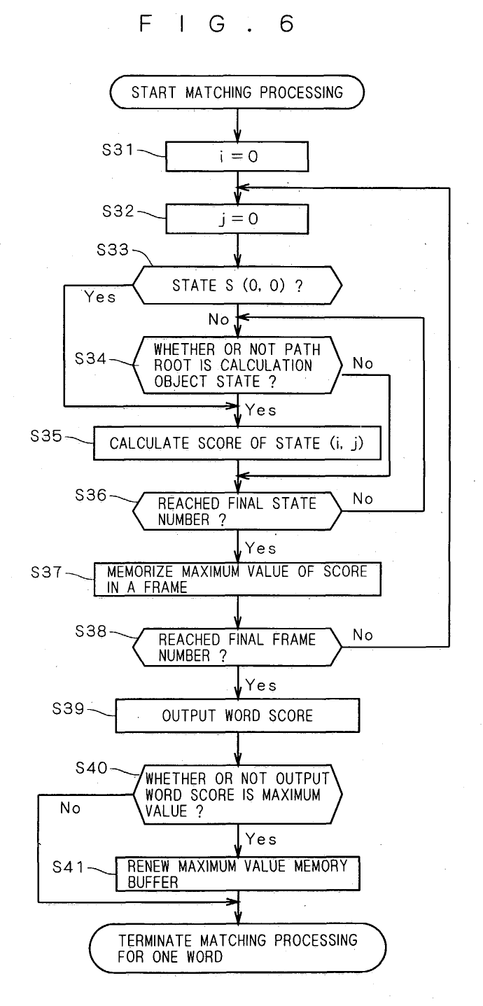

The operation of word matching processor 24 will be explained with reference to FIG. 6. The processing of steps S31 through S36 shown in FIG. 6 is identical with the processing of steps S11 through S16 shown in FIG. 3. Accordingly, no repetitive explanation will be given for these steps.

In step S36, it is judged whether or not the present state number has already reached the final number (J). When the present state number has not yet reached the final number, the state number is incremented by 1 and the processing of the step S34 and succeeding steps is repeated. On the other hand, when the present state number has already reached the final number, the processing flow proceeds to step S37.

In step S37, a score having the maximum value is selected from the scores of respective states having state numbers 0 through J in one frame which are obtained by repeating the processing of steps S34 through S36. The score having the maximum value is then memorized in the temporary memory buffer 28. This memorization is temporary and accordingly there is no necessity of storing the data for a relatively long time, whereas the maximum value of each frame memorized in the maximum value memory buffer 8 needs to be stored for a long time. Hence, a buffer used as the temporary memory buffer 28 is different from the maximum value memory buffer 8.

After memorizing the maximum value of score in one frame, it is judged in step S38 that the present frame number has already reached the final number (I). When the present frame number has not yet reached the final number, the frame number is incremented by 1 and the processing of the step S32 and succeeding steps is repeated.

When the present frame number has already reached the final number, the processing flow proceeds to step S39 in which the word score serving as the cumulative score at the final state S(I, J) is sent to the matching result judge 9.

The matching result judge 9 compares the word score having been previously received with the latest word score received from the word matching processor 24. When the latest word score is the maximum value among them, this information as information D3 is fed back to the word matching processor 24 (step S40).

The word matching processor 24 receives the information D3. When the word score obtained in the step S39 is the maximum value, the maximum value of score at each frame stored in the temporary memory buffer 28 is written into the maximum value memory buffer 8, thereby renewing the memorized contents of maximum value memory buffer 8 (step S41).

After accomplishing the renewal of memorized contents in maximum value memory buffer 8, the matching operation for one word model selected by the matching object word selector 3 terminates.

Furthermore, when the word score obtained in the step S39 is not the maximum value, the matching operation for one word model selected by the matching object word selector 3 terminates without renewing the memorized contents of maximum value memory buffer 8.

<B-2. Characteristic Function and Effect>

According to the above-described speech recognition apparatus 200, in the HMM matching processing performed in the word matching processor 24, a judgment is made to check whether or not the score of a path root of the state serving as matching object is within the predetermined range being set based on the maximum value of score of each frame, which is memorized in the maximum value memory buffer 8 connected to the word matching processor 24. When the score of this path root is within the above-described range, the score of this path root is counted and the cumulative score is obtained. When the score of this path root is outside the above-described range, the calculation of score for the state of the matching object is omitted. In this manner, even in the matching processing of speech recognition performed for each word, it becomes possible to perform the thinning-out processing similar to a so-called beam search method. The time required for the matching processing of one word can be reduced.

Furthermore, the word matching processor 24 causes the temporary memory buffer 28 to store the maximum value of score in each state of each frame. After the matching processing for one word model is accomplished, the maximum value of score in each frame stored in the temporary memory buffer 28 is written into the maximum value memory buffer 8 only when the word score of this word model is the maximum value, thereby renewing the memory contends of maximum value memory buffer 8. For example, there is the possibility that a certain word model happens to show good matching result in only limited number of frames. However, even when the score of such a word model is stored in the maximum value memory buffer 8, it is possible to prevent the matching result from being incorrectly obtained.

Furthermore, the word assembly producer 25 produces an assembly of similar words. The matching object word selector 3 selects the representative model from each word model, and sends the selected representative model to the word matching processor 24 in which the selected representative model is subjected to the matching processing. Then, to make a judgment as to whether or not the matching processing should be applied to the assembly of word models from which the above-described representative model is extracted, the preprocessing operation is performed based on the word score resulting from the above matching processing. Accordingly, the time required for the matching processing can be greatly reduced. The high-speed processing is realized.

Furthermore, the word assembly producer 25 receives the output word data D1 sent from the matching result judge 9 to perform statistical processing. Based on this statistical processing, the word assembly producer 25 gives a higher priority to a specific word having been frequently output from the word matching processor 24, so that this specific word can be selected as the representative model of the word assembly in the matching object word selector 3. Thus, it becomes possible to select the frequently entered word as matching object at a higher probability. For example, when the vocabulary of speech input words is small, and furthermore when there is some deviation among the entered words, this embodiment makes it possible to greatly increase the hitting rate in the matching processing. The matching processing speed can be further increased.

<B-3. Modified Embodiment>

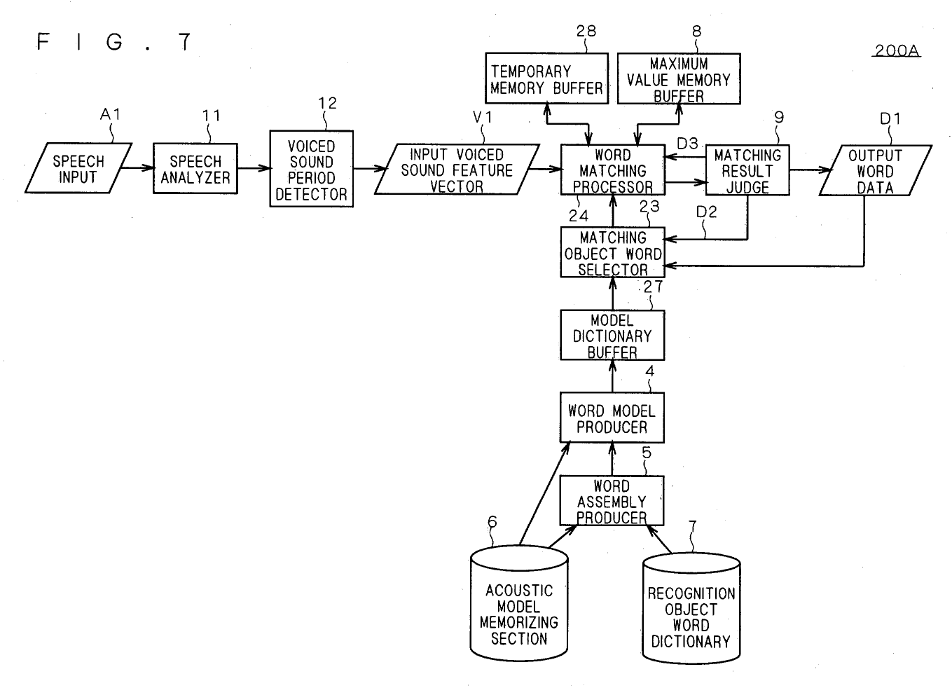

FIG. 7 shows a modified arrangement of the above-described speech recognition apparatus 200. In FIG. 7, the same components shown in the speech recognition apparatuses 100 and 200 explained with reference to FIGS. 2 and 5 are denoted by the same reference numerals. Accordingly, no repetitive explanation will be given for these components.

According to a speech recognition apparatus 200A shown in FIG. 7, the assembly data of word models produced by the word model producer 4 is sent to a model dictionary buffer 27 which temporarily stores the received assembly data of word models.

Then, the assembly data of word models held in the model dictionary buffer 27 is sent to a matching object word selector 23 which selects one word model as matching object.

The matching object word selector 23 has a function similar to that of the matching object word selector 3 explained with reference to FIG. 2. Furthermore, the matching object word selector 23 has a function of receiving the output word data D1 sent from the matching result judge 9 to perform statistical processing and then rearranging the assembly data of word models stored in the model dictionary buffer 27 to rank up a specific assembly containing a frequently output word so that such a frequently output word can be selected by the matching object word selector 23 at a higher probability. Alternatively, it is possible to rearrange the data in such a manner that the frequently output word is ranked high in the assembly based on the above-described statistical processing.

As described above, the speech recognition apparatus 200A includes the model dictionary buffer 27 which stores the assembly data of word models produced by the word model producer 4. The matching object word selector 23 receives the output word data D1 sent from the matching result judge 9 to perform statistical processing and then rearranges the assembly data of word models stored in the model dictionary buffer 27 so that the frequently output word can be selected at a higher probability. Hence, when there is some deviation among the entered words, this embodiment makes it possible to greatly increase the hitting rate in the matching processing. The matching processing speed can be further increased.

<C. Other Modifications>

According to the above-described speech recognition apparatuses 100 and 200, the word assembly producers 5 and 25 operate to produce an assembly of words similar in several leading phonemes. However, this is a mere example. It is therefore preferable that the word assembly producers 5 and 25 produce an assembly of words with reference to the word length of registered words.

More specifically, the acoustic model produced based on the registered word possesses the information relating to phoneme and continuation time length, from which the word length can be easily estimated. It is therefore easy to produce an assembly of words based on the word length.

When this method is employed, as the word length of a speech input word correlates with a frame number, it is preferable that the input word length is estimated based on the frame number and then the matching object word selector 3 primarily selects the assembly of words having the word length similar to the input word length. With this method, it becomes possible to realize high-speed matching processing.

Furthermore, the information of phoneme includes the information relating to the power (i.e., intensity of sound) and its variation. Hence, it is preferable to produce an assembly of words based on the variation of power in the registered word or based on the number of times with respect to silent sound (or low power).

Needless to say, it is possible to use an arbitrary combination of the similarity of several leading phonemes, the word length, and the variation of power as criteria in producing the assembly of words.

<D. Other Embodiment of Matching Processing>

Although the above-described first and second embodiments are explained based on the HMM matching processing, it is also possible to use the matching processing relying on a DP matching method. Hereinafter, the DP matching method will be explained.

Even if the same person phonates the same word, its continuation time varies each time. Furthermore, it expands or contracts non-linearly. Accordingly, in the comparison between the standard pattern and each input speech, the time normalization is introduced to non-linearly expand or contract the time axis.

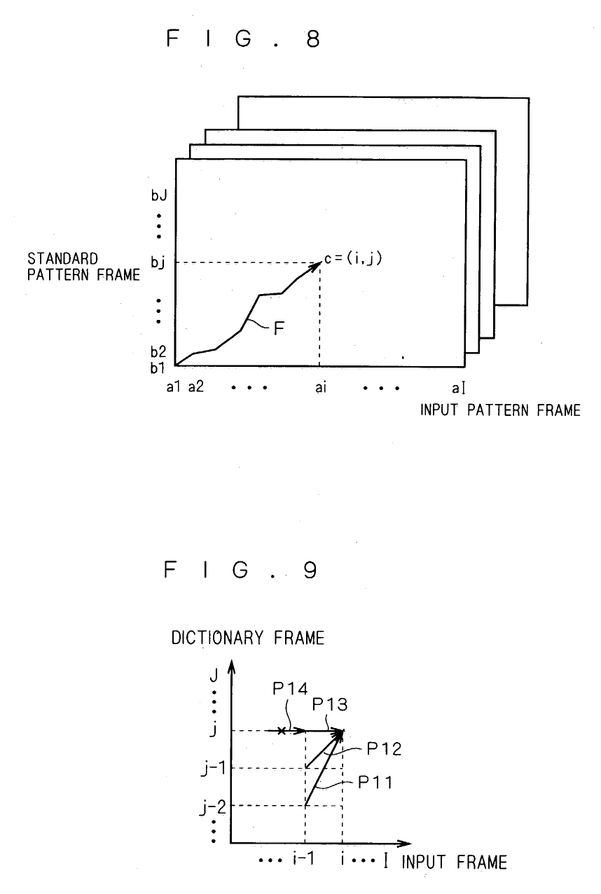

It is now assumed that two time series to be compared are given as A=a1, a2, - - - , ai, - - - aI and B=b1, b2, - - - , bj, - - - bI. As shown in FIG. 8, a plane is given in which the abscissa represents an input pattern frame consisting of time-series A and the ordinate represents a standard pattern frame consisting of time-series B. As a plurality kinds of standard patterns are prepared, a plurality of planes are supposed so as to fit to respective standard patterns. In this case, the relationship between the time axis of time-series A and the time axis of time-series B, i.e., a time expansion and contraction function, is expressed by series F of lattice point c=(i, j) on the plane.

When a spectrum distance between two feature vectors ai and bi is expressed by d(c)=d (i, j), a sum of distances H (F) along the series F is expressed by the following numerical formula (4).

$$H ( F ) = \frac{\sum d ( {C}_{k} ) \cdot {W}_{k}}{\sum {W}_{k}} \qquad ( 4 )$$

When the sum H (F) has a small value, it means that there is good correspondence between the time-series A and the time-series B.

In the above formula (4), Wₖ represents a positive weight relating to the series F. By adding various restrictions for suppressing monotonicity and continuity as well as extreme expansion and contraction, the limitation of the time expansion and contraction function F, i.e., an inclination limit to the path, is given as schematically shown in FIG. 9.

In FIG. 9, the abscissa represents the frame of input speech and the ordinate represents the frame of word memorized in the dictionary, which are referred to as i axis and j axis showing a path model of the DP matching.

As shown in FIG. 9, when four paths P11, P12, P13 and P14 are supposed, it is prohibited to continuously locate two paths, such as P13 and P14, when their dictionary frame numbers are not altered. In this case, the path P14 is excluded from calculation objects. The paths P11 to P13 converge to a point (i, j).

According to the path model shown in FIG. 9, the cumulative calculation is expressed by the following numerical formula (5).

$$g ( i , j ) = min [ \begin{matrix}g ( i - 1 , j ) \\ g ( i - 1 , j - 1 ) \\ g ( i - 1 , j - 2 )\end{matrix} ] + d ( i , j ) \qquad ( 5 )$$

In the numerical formula (5), g (i, j) represents a cumulative distance at the point (i, j), g (i−1, j) represents a cumulative distance of path P3, g (i−1, j−1) represents a cumulative distance of path P2, g (i−1, j−2) represents a cumulative distance of path P1, and d (i, j) represents an euclidean distance.

It is now assumed that g (1, 1)=d (1, 1). Under this assumption, the value of the above-described formula (5) is calculated by successively changing the value of i from 1 to I while j is fixed to 1. Next, the value of j is incremented by 1, the calculation is again performed by changing the value of i. This operation is repeated until the value of j reaches J, thereby obtaining the cumulative distance resulting from the time normalization applied between two time-series A and B.

The cumulative distance thus obtained is a cumulative score explained in the HMM matching processing. Judging the similarity between the input word and the registered word based on the cumulative distance is the matching processing based on the DP matching method. According to the present invention, it is possible to replace the HMM matching processing with the matching processing based on the DP matching method.

While the invention has been shown and described in detail, the foregoing description is in all aspects illustrative and not restrictive. It is therefore understood that numerous other modifications and variations can be devised without departing from the scope of the invention.

What is claimed is:

1. A speech recognition apparatus comprising:
an acoustic processing section for converting an input speech signal given as a time-series signal into a feature vector and outputting a plurality of dissected frames;
a word model producing section for producing at least one word model based on a recognition object word prepared beforehand and an acoustic model;
a matching processing section for performing matching processing for collating said at least one word model with said feature vector for each word by using a Viterbi algorithm which obtains a final cumulative probability along a state sequence giving a maximum probability; and
a maximum value memorizing section for memorizing a maximum value in each frame of a score calculated based on the probability for a plurality of states contained in said plurality of frames, wherein
said matching processing section selects a calculation object state in which a score is to be calculated from said plurality of states based on the maximum value of the score and performs thinning-out processing for omitting calculation of scores for the states not selected as said calculation object state.

2. The speech recognition apparatus in accordance with claim 1, wherein
said matching processing is a matching processing using a hidden Markov model, applied to said plurality of states disposed in a matrix pattern, which obtains said cumulative score as matching result by specifying a path giving a maximum cumulative score among a plurality of paths selectable for reaching a final state while accumulating said scores of the states, and
said thinning-out processing performed in said matching processing section, during said matching processing, includes the processing of designating a present state currently serving as judgment object of score calculation as said calculation object state when a score of a previous state passing immediately before reaching said present state is within a predetermined range being set based on said maximum value of the score memorized in said maximum value memorizing section, and also includes the processing of omitting calculation of score for said present state when the score of said previous state is outside said predetermined range.

3. The speech recognition apparatus in accordance with claim 2, wherein said matching processing section further includes a function of comparing said maximum value of the score memorized in said maximum value memorizing section with a latest score of each state obtained through said matching processing and renewing said maximum value of the score memorized in said maximum value memorizing section by the latest score when said latest score exceeds said maximum value of the score.

4. The speech recognition apparatus in accordance with claim 2, wherein
said at least one word model includes a plurality of word models,
said speech recognition apparatus further comprises a matching result judging section which receives information relating to said matching result from said matching processing section and compares said matching result of a latest word model having been received most recently with said matching result of other word model having been already received to judge best matching result, and
said matching processing comprises
a function of obtaining the maximum value of a latest score in each state of each frame obtained through said matching processing and storing said obtained maximum value in a predetermined temporary memorizing section for each frame, and
a function of receiving information relating to judgment result from said matching result judging section and renewing said maximum value of the latest score memorized in said maximum value memorizing section by the maximum value of each state of each frame memorized in said temporary memorizing section when said matching result of said latest word model is said best matching result.

5. The speech recognition apparatus in accordance with claim 2, wherein
said at least one word model includes a plurality of word models,
said word model producing section has a function of classifying said plurality of word models into a plurality of word model assemblies based on a predetermined common term and outputting the classified word model assemblies, and
said speech recognition apparatus further includes a matching object word selecting section for receiving said plurality of word model assemblies and selecting a representative model from each word model assembly to be sent to said matching processing section, and reflecting matching result of said representative model to a decision as to whether or not said matching processing should be applied to the word models remaining in said each word model assembly.

6. The speech recognition apparatus in accordance with claim 5, wherein said predetermined common term used in classifying the word models by said word model producing section is similarity with respect to two or more predetermined number of leading phonemes appearing from the head of said recognition object word.

7. The speech recognition apparatus in accordance with claim 5, wherein said predetermined common term used in classifying the word models by said word model producing section is word length of said recognition object word.

8. The speech recognition apparatus in accordance with claim 5, wherein said predetermined common term used in classifying the word models by said word model producing section is number of times with respect to silent sound or low power of said recognition object word obtainable from information relating to variation of power.

9. The speech recognition apparatus in accordance with claim 5, wherein
said speech recognition apparatus further comprises
a matching result judging section which receives information relating to said matching result from said matching processing section and compares said matching result of a latest word model having been received most recently with said matching result of other word model having been already received, and then outputs a word model showing best matching result as word data corresponding to input word, and
said word model producing section has a function of receiving said word data from said matching result judging section to perform statistical processing, and then giving a priority to a frequently output word model so that said frequently output word model can be selected by said matching object word selecting section at a higher probability.

10. The speech recognition apparatus in accordance with claim 5, wherein
said speech recognition apparatus further comprises
a matching result judging section which receives information relating to said matching result from said matching processing section and compares said matching result of a latest word model having been received most recently with said matching result of other word model having been already received, and then outputs a word model showing best matching result as word data corresponding to input word, and
a model dictionary section which temporarily stores data of said word model produced from said word model producing section, and further
said matching object word selecting section has a function of receiving said word data from said matching result judging section to perform statistical processing, and then rearranging the data of said word model stored in said model dictionary section so that a frequently output word model can be selected at a higher probability.
